(19) United States
(12) Patent Application Publication
(10) Pub. No.: US 2014/0354771 A1
(43) Pub. Date: Dec. 4, 2014

(54) EFFICIENT MOTION ESTIMATION FOR 3D STEREO VIDEO ENCODING

(71) Applicant: ATI Technologies ULC, Markham (CA)

(72) Inventors: Jiao Wang, Richmond Hill (CA); Gabor Sines, Toronto (CA)

(21) Appl. No.: 13/904,766

(22) Filed: May 29, 2013

(51) Int. Cl. H04N 13/00

(52) U.S. Cl. CPC H04N 13/0048
USPC 348/43

(57) ABSTRACT

An efficient motion estimation method and apparatus for 3D stereo video encoding is described herein. In an embodiment of the method, an enhancement layer motion vector for a frame is determined by obtaining a motion vector of a co-located macroblock (MB) from the same frame of a base layer. The motion vectors of a predetermined number of surrounding MBs from the same frame of the base layer are also obtained. A predicted motion vector for the MB of the frame in the enhancement layer is determined using, for example, a median value from the motion vectors associated with the co-located MB and the predetermined number of surrounding MBs. A small or less than full range motion refinement is performed to obtain a final motion vector, where full range refers to the maximum search range supported by an encoder performing the method.

### TECHNICAL FIELD

The disclosed embodiments are generally directed to encoding, and in particular, to 3D stereo video encoding.

### BACKGROUND

The transmission and reception of stereo video data over various medium is ever increasing. Typically, video encoders are used to compress the stereo video data and reduce the amount of stereo video data transmitted over the medium. Efficient encoding of the stereo video data is a key feature for encoders and is important for real time applications.

The motion picture experts group 2 (MPEG-2) introduced the MPEG-2 multiview profile as an amendment to the MPEG-2 standard to enable multiview video coding. The amendment defines the base layer which is associated with the left view and the enhancement layer which is associated with the right view. The base layer is encoded in a manner compatible with common MPEG-2 decoders. In particular, the base layer uses a conventional motion estimation process which requires a full exhaustive search in a reference frame for each macroblock (MB) of a current frame to find the best motion vector which results in the lowest rate distortion cost. For the enhancement layer, the conventional motion estimation process is performed with respect to the base layer and the enhancement layer. This is very time consuming. Alternatively, the motion vector from the base layer frame may be used as the motion vector for the co-located MB in the enhancement layer frames and may save more cycles for the motion estimation process. However, taking the motion vector directly from one view and using it for the other view is not optimal and introduces visual quality degradation.

### SUMMARY OF EMBODIMENTS

An efficient motion estimation method and apparatus for 3D stereo video encoding is described herein. In an embodiment of the method, an enhancement layer motion vector for a frame is determined by obtaining a motion vector of a co-located macroblock (MB) from the same frame of a base layer. The motion vectors of a predetermined number of surrounding MBs from the same frame of the base layer are also obtained. A predicted motion vector for the MB of the frame in the enhancement layer is determined using, for example, a median value from the motion vectors associated with the co-located MB and the predetermined number of surrounding MBs. A small or less than full range motion refinement is performed to obtain a final motion vector, where full range refers to the maximum search range supported by an encoder performing the method.

### BRIEF DESCRIPTION OF THE DRAWINGS

A more detailed understanding may be had from the following description, given by way of example in conjunction with the accompanying drawings wherein:

FIG. 1 is an example system with a video encoder according to some embodiments;

FIG. 2 is an example motion estimation method;

FIG. 3 is an example diagram of frames and macroblocks for a base layer and an enhancement layer according to some embodiments;

FIG. 4 is an example flowchart for enhancement layer encoding according to some embodiments;

FIG. 5 is an example system architecture that uses video encoders according to some embodiments; and

FIG. 6 is a block diagram of an example source or destination device for use with an embodiment of a video encoder according to some embodiments.

### DETAILED DESCRIPTION

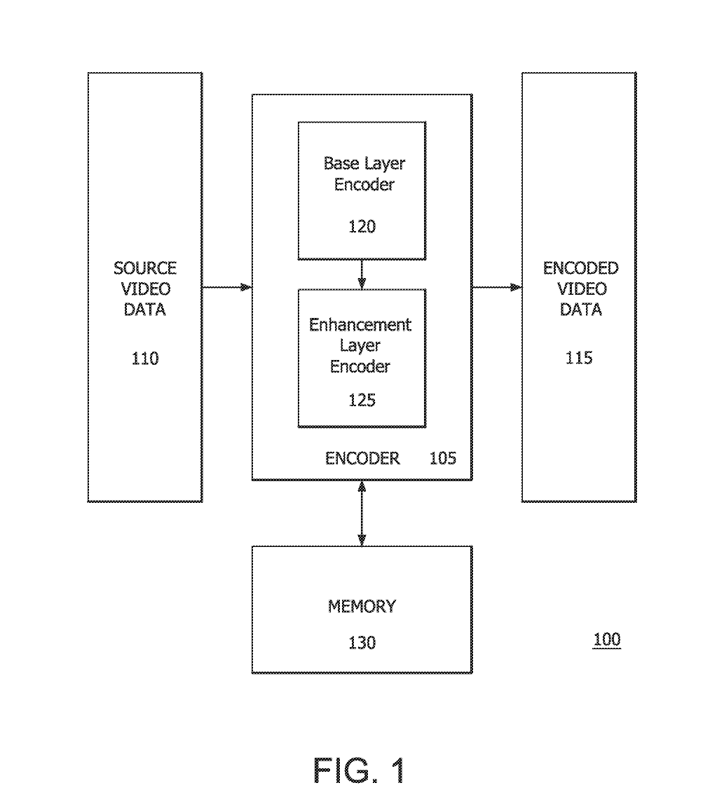

FIG. 1 is a block diagram of a system 100 that includes a stereo video encoder 105 according to some embodiments. The stereo video encoder 105 receives source video data 110 and outputs encoded video data 115. The stereo video encoder 105 includes a base layer encoder 120 and an enhancement layer encoder 125, and is connected to a memory 130 for storing and reading reference data as described herein. For illustrative purposes only, the base layer encoder 120 uses a conventional motion estimation process which requires a full exhaustive search within a search window in a reference frame stored in memory 130 for each macroblock (MB) of a current frame in the source video data 110 to find the best motion vector which results in the lowest rate distortion cost. The search window may comprise all or a portion of the reference frame. The enhancement layer encoder 125, when using a conventional motion estimation process, uses the full exhaustive search method as described above and an inter-view prediction from the base layer encoder 120 to find the best motion vector which results in the lowest rate distortion cost.

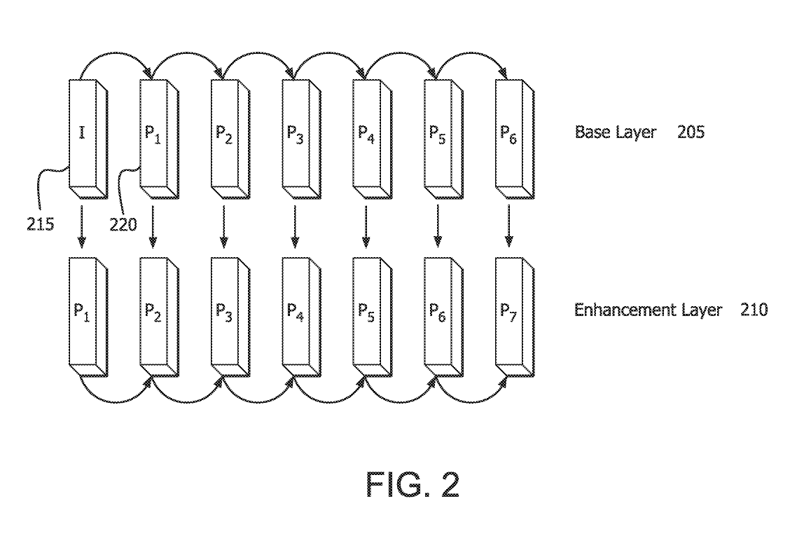

The motion picture experts group 2 (MPEG-2) introduced the MPEG-2 multiview profile as an amendment to the MPEG-2 standard to enable multiview video coding. As shown in FIG. 2, the amendment defines a base layer 205 which is associated with the left view and an enhancement layer 210 which is associated with the right view. In the MPEG-2 multiview profile, there are Intra-coded picture frames (I-frames) 215 and predicted picture frames (P-frames) 220. The I-frame 215 is the least compressed frame and is essentially a fully specified picture. The P-frames 220 hold only a part of the image information, need less space to store than the I-frame 215, and thus improve video compression rates. In particular, the P-frame 220 holds only the changes in the image from the previous frame. Both frame types contain a predetermined number of macroblocks, where each macroblock may have, for example, a predetermined number of raster lines depending on the video encoding standard or scheme being used.

FIG. 2 also depicts an illustrative motion estimation diagram. For the base layer 205, the base layer P-frames 220 are coded only using a temporal prediction within the same layer. For the enhancement layer 210, both temporal prediction within the same layer and inter-view prediction from the base layer 205 are supported. In particular, in the base layer 205, P-frame P1 is predicted from the I-frame I, P2 is predicted from P1, P3 is predicted from P2 and so on. In the enhancement layer 210, two types of prediction are enabled. The first prediction is based on the previous encoded frames in the same layer. For example, in the enhancement layer 210, frame P2 is predicted from frame P1, frame P3 is predicted from frame P2 and so on. The second prediction is based on frames from the base layer 205. For example, enhancement layer 210 frame P2 is predicted from base layer 205 frame P1, enhancement layer 210 frame P3 is predicted from base layer 205 frame P2 and so on. This conventional motion estimation process requires a full exhaustive search in a reference frame for each macroblock (MB) of a current frame to find the best motion vector which results in the lowest rate distortion cost. This is very time consuming.

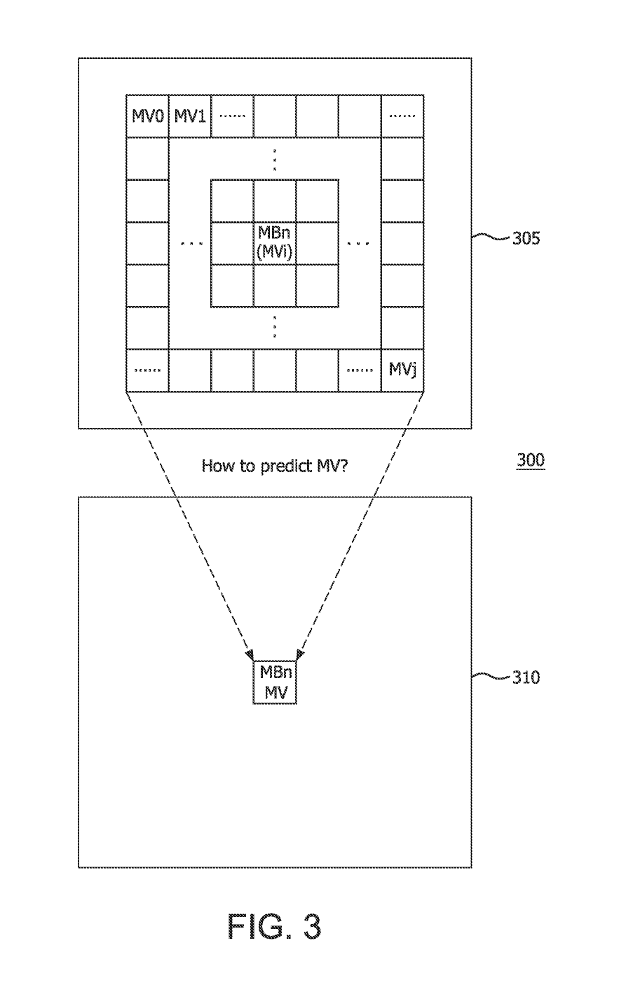

FIG. 3 is an example diagram 300 of a base layer P-frame P1 305 and an enhancement layer P-frame P2 310 according to some embodiments. Using the conventional motion estimation process to predict a motion vector for MBₙ in the enhancement layer P-frame P2 310, a motion estimation module would loop over the full search area from a base layer P1 reference frame and an enhancement layer P1 frame to find the best match and record its best motion vector (MV) as MVₙ.

Described herein is a method in accordance with some embodiments that provides efficient motion estimation for stereo video data, 3D stereo video data and the like. In particular, if the motion vector of the co-located MBₙ from the base layer frame P1 is used, then exhaustive motion search is not needed for MBₙ in the enhancement layer. This approach can be further applied to all MBs in the enhancement layer frames. The efficiency is based on the fact that the left and right view images are captured at the same time for the same scene from different angles and are correlated. This is particularly true in the case of stereo video data. Since the left and right view images are close to the eye distance, the motion information should be highly correlated between the left and right view images.

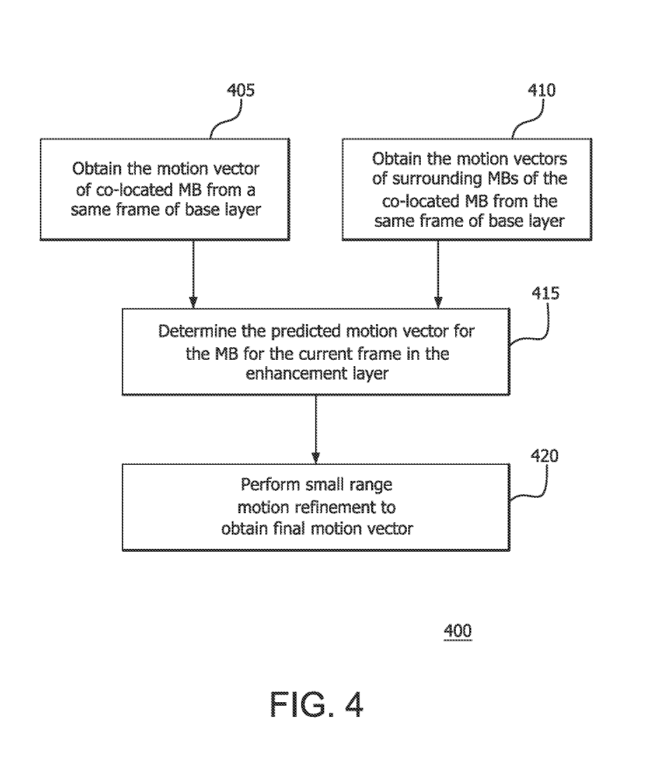

Based on the above underpinnings, a fast and efficient motion estimation method utilizes motion vector information from the base layer to predict the motion vector for the co-located area in the enhancement layer without sacrificing quality. FIG. 4 is an example flowchart 400 for enhancement layer encoding according to some embodiments. Referring also to FIGS. 1 and 3 as appropriate, a motion vector (MV) for a MB in the enhancement layer P-frame P2 310 may be determined by obtaining the motion vector of the co-located MB and the motion vectors from the surrounding MBs from the same frame of the base layer, i.e. base layer P-frame P1 305 (405 and 410). In FIG. 3, the particular MB is identified as MBₙ as described herein below. These motion vectors are then used to determine a predicted MV for MBₙ (415). The predicted MV may be determined using, for example, a median value for the obtained motion vectors, applying a weighting function based on location and distance of the particular MB from the identified MB, an average value for the obtained motion vectors, a combination thereof or other like methods. In accordance with some embodiments as described in detail herein below, a very small range motion refinement is then performed to obtain a more accurate motion vector up to a half pixel resolution based on the predicted motion vector (420).

Referring to FIG. 3 and for illustrative purposes only, assume the motion vector of MBₙ in the base layer P-frame P1 305 is MVᵢ and the motion vectors of its surrounding MBs are MV₀ to MVⱼ. The motion vector MVₙ of MBₙ in the enhancement layer P-frame P2 310 is calculated as follows using the median method:

$${MV}_{n} = arg {min}_{0 \leq p \leq j} {\sum }_{q = 0 , q \neq p}^{j} ‖ {MV}_{q} - {MV}_{p} ‖$$

In some embodiments, the median method is used over an average method to determine the predicted motion vector because the motion trend could become inaccurate due to averaging over all of the motion vectors. For example, the value may be zero. The number of neighbors from the base layer to use in determining the predicted motion vector MVₙ for the enhancement layer may be dependent upon performance, speed and other like factors and may change from frame to frame, over time or based on other inputs (e.g., user input, performance inputs, power consumption inputs, etc.).

Centered on the generated predicted motion vector MVₙ, motion refinement can then be performed in a small search range, as compared to the base layer, to get a final motion vector with higher precision for MBₙ in the enhancement layer P-frame P2 310. With respect to the term “small search range”, assume that the original full search range that a video encoder can support is M×M. The motion refinement in accordance with some embodiments can then be done in a range with size N×N with 1≦M/N≦M.

The motion refinement may be more applicable and useful in certain type of applications. For example, if an input stream has very small motion between frames, then in most cases there will not be much of a difference between the compressed stream size using an integer pixel based motion vector or a half pixel based motion vector. The small motion refinement is more useful for cases where there is big motion between frames in the input video stream, such as for video gaming applications. In these cases, the small motion refinement helps enhance the precision of the motion estimation and reduces the rate distortion costs that may be needed for improving the compression ratio.

The methods described herein can be applied to all MBs in the enhancement layer frames and the exhaustive search can be avoided for the enhancement layer frames. The efficient motion estimation algorithm for MPEG-2 based 3D stereo video effectively makes use of the motion vector information of the left view to predict the motion vector of the co-located area in the right view to simplify the time consuming motion estimation process. The benefits of such a speedup would benefit, for example, systems with limited processing power, or could help in handling multiple encoding jobs. The described method can increase throughput gains in some systems as it is known that the exhaustive motion search process occupies a large percentage of the entire encoding time.

The apparatus and methods described herein are applicable to MPEG-2 based 3D stereo video coding in a variety of frame compatible formats including the top and bottom format, the side by side format, the horizontal or vertical line interleaved format, and the checkerboard format. For each case, the two views are downsized horizontally or/and vertically and packed in a single frame. For each MB of the right view, the MV can be predicted from the motion vectors of the co-located MBs in the left view using the method described herein. In this manner, the exhaustive search can be avoided for a half area of each frame, which in turn speeds up the overall encoding process.

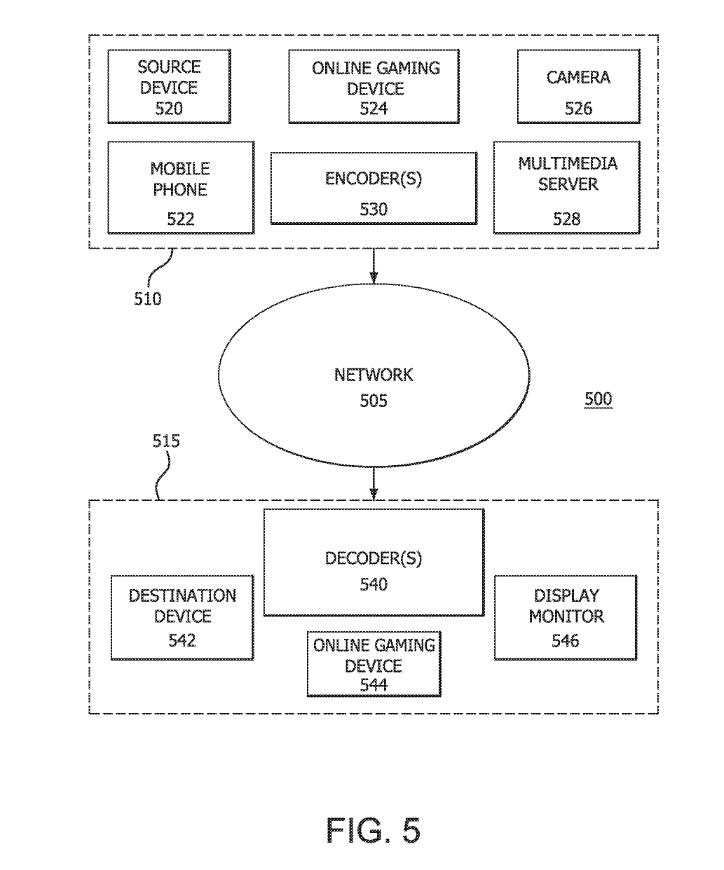

FIG. 5 is an example system 500 that uses efficient motion estimation video encoders as described herein below to send encoded video data over a network 505 from a source side 510 to a destination side 515, according to some embodiments. The source side 510 includes any device capable of storing, capturing or generating video data that may be transmitted to the destination side 515. The device may include, but is not limited to, a source device 520, a mobile phone 522, online gaming device 524, a camera 526 or a multimedia server 528. The video data from these devices feeds encoder(s) 530, which in turn encodes the video data as described herein below.

The encoded video data is processed by decoder(s) 540, which in turn sends the decoded video data to destination devices, which may include, but is not limited to, destination device 542, online gaming device 544, and a display monitor 546. Although the encoder(s) 530 and decoder(s) 540 are shown as a separate device(s), it may be implemented as an external device or integrated in any device that may be used in storing, capturing, generating, transmitting or receiving video data.

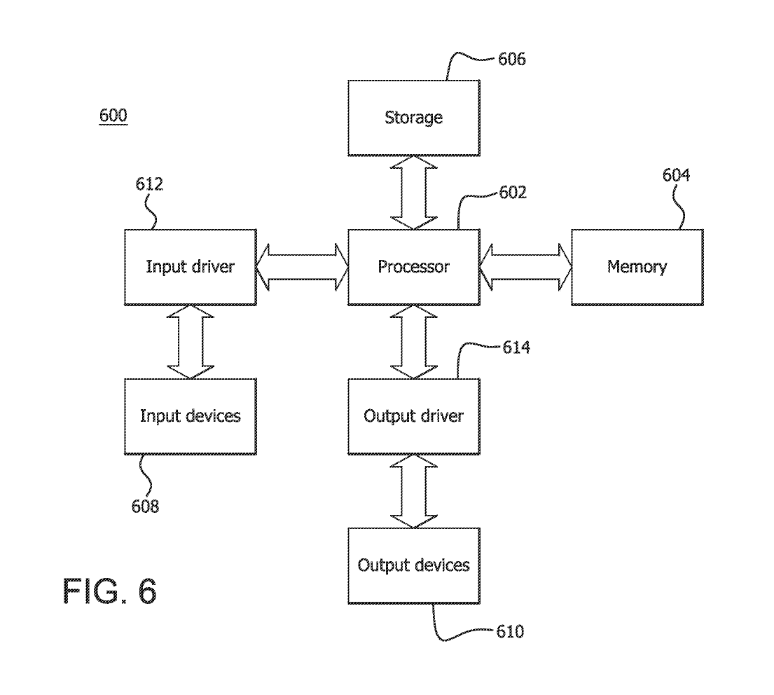

FIG. 6 is a block diagram of a device 600 in which the efficient video encoders described herein may be implemented, according to some embodiments. The device 600 may include, for example, a computer, a gaming device, a handheld device, a set-top box, a television, a mobile phone, or a tablet computer. The device 600 includes a processor 602, a memory 604, a storage 606, one or more input devices 608, and one or more output devices 610. The device 600 may also optionally include an input driver 612 and an output driver 614. It is understood that the device 600 may include additional components not shown in FIG. 6.

The processor 602 may include a central processing unit (CPU), a graphics processing unit (GPU), a CPU and GPU located on the same die, or one or more processor cores, wherein each processor core may be a CPU or a GPU. The memory 604 may be located on the same die as the processor 602, or may be located separately from the processor 602. The memory 604 may include a volatile or non-volatile memory, for example, random access memory (RAM), dynamic RAM, or a cache. In some embodiments, the high throughput video encoders are implemented in the processor 602.

The storage 606 may include a fixed or removable storage, for example, a hard disk drive, a solid state drive, an optical disk, or a flash drive. The input devices 608 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 610 may include a display, a speaker, a printer, a haptic feedback device, one or more lights, an antenna, or a network connection (e.g., a wireless local area network card for transmission and/or reception of wireless IEEE 802 signals).

The input driver 612 communicates with the processor 602 and the input devices 608, and permits the processor 602 to receive input from the input devices 608. The output driver 614 communicates with the processor 602 and the output devices 610, and permits the processor 602 to send output to the output devices 610. It is noted that the input driver 612 and the output driver 614 are optional components, and that the device 600 will operate in the same manner if the input driver 612 and the output driver 614 are not present.

The video encoders described herein may use a variety of encoding schemes including, but not limited to, Moving Picture Experts Group (MPEG) MPEG-1, MPEG-2, MPEG-4, MPEG-4 Part 10, Windows®*.avi format, Quicktime® *.mov format, H.264 encoding schemes, High Efficiency Video Coding (HEVC) encoding schemes and streaming video formats.

In general, in accordance with some embodiments, a method for encoding a frame in an enhancement layer includes obtaining a motion vector of a co-located macroblock from a same frame, as the frame, in a base layer. The motion vectors from a predetermined number of neighbor macroblocks from the same frame of the base layer are also obtained. A predicted motion vector is determined based on the motion vector and the motion vectors for a macroblock of the frame in the enhancement layer. In some embodiments, a less than full range motion refinement is performed on the predicted motion vector to obtain a final motion vector. The less than full range motion refinement is centered on the predicted motion vector. In some embodiments, a median value of the motion vector and the motion vectors is used to determine the predicted motion vector. In some embodiments, a weighting function is applied to the motion vectors based on a predetermined criteria. In some embodiments, the predetermined number of neighbor macroblocks is based on a desired level of accuracy or on a desired level of resolution.

In accordance with some embodiments, a method for encoding includes obtaining a motion vector of a co-located macroblock from a left view frame and motion vectors from a predetermined number of neighbor macroblocks from the left view frame. A predicted motion vector is then determined based on the motion vector and the motion vectors for a macroblock of a right view frame associated with the left view frame.

In accordance with some embodiments, a device includes a base layer encoder and an enhancement layer encoder connected to the base layer encoder, which encodes a frame in an enhancement layer. The enhancement layer encoder obtains a motion vector of a co-located macroblock from a same frame, as the frame, in a base layer and motion vectors from a predetermined number of neighbor macroblocks from the same frame of the base layer. The enhancement layer encoder determines a predicted motion vector based on the motion vector and the motion vectors for a macroblock of the frame in the enhancement layer. In some embodiments, the enhancement layer encoder performs a less than maximum range motion refinement on the predicted motion vector to obtain a final motion vector, where the device supports up to a maximum range search. In some embodiments, the frame and same frame are stereo video data frames.

In accordance with some embodiments, a method for encoding a frame in an enhancement layer includes determining a predicted motion vector for a macroblock in the frame in the enhancement layer based on a motion vector of a co-located macroblock from the same frame in the corresponding base layer and motion vectors for neighboring macroblocks in the base layer. In some embodiments, a less than full range motion refinement is performed on the predicted motion vector to obtain a final motion vector. The less than full range motion refinement is centered on the predicted motion vector. In some embodiments, a median value of the motion vector and the motion vectors is used to determine the predicted motion vector. In some embodiments, a weighting function is applied to the motion vectors based on a predetermined criteria. In some embodiments, the number of neighbor macroblocks used is based on a desired level of accuracy or on a desired level of resolution.

In accordance with some embodiments, a method for encoding includes determining a predicted motion vector for a macroblock in a right view frame based on a motion vector of a co-located macroblock from the same frame in a corresponding left view frame and motion vectors for neighboring macroblocks in the left view frame.

In accordance with some embodiments, a device includes a base layer encoder and an enhancement layer encoder connected to the base layer encoder. The enhancement layer encodes a frame in an enhancement layer. In particular, the enhancement layer encoder determines a predicted motion vector for a macroblock in the frame in the enhancement layer based on a motion vector of a co-located macroblock from the same frame in the base layer and motion vectors for neighboring macroblocks in the base layer. In some embodiments, the enhancement layer encoder performs a less than maximum range motion refinement on the predicted motion vector to obtain a final motion vector. In some embodiments, the enhancement layer encoder performs a less than maximum range motion refinement on the predicted motion vector to obtain a final motion vector, where the device supports up to a maximum range search. In some embodiments, the frame and same frame are stereo video data frames.

It should be understood that many variations are possible based on the disclosure herein. Although features and elements are described above in particular combinations, each feature or element may be used alone without the other features and elements or in various combinations with or without other features and elements.

The methods provided, to the extent applicable, may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the embodiments.

The methods or flow charts provided herein, to the extent applicable, may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for encoding a frame in an enhancement layer, comprising:
determining a predicted motion vector for a macroblock in the frame in the enhancement layer based on a motion vector of a co-located macroblock from the same frame in the corresponding base layer and motion vectors for neighboring macroblocks in the base layer.

2. The method of claim 1, further comprising:
performing a less than full range motion refinement on the predicted motion vector to obtain a final motion vector.

3. The method of claim 1, wherein a median value of the motion vector and the motion vectors is used to determine the predicted motion vector.

4. The method of claim 1, wherein a weighting function is applied to the motion vectors based on a predetermined criteria to determine the predicted motion vector.

5. The method of claim 1, wherein the less than full range motion refinement is centered on the predicted motion vector.

6. The method of claim 1, wherein a number of neighboring macroblocks used is based on a desired level of accuracy.

7. The method of claim 1, wherein a number of neighboring macroblocks used is based on at least one of performance inputs, power consumption inputs and user inputs.

8. The method of claim 1, wherein the number of neighboring macroblocks is based on a desired level of resolution.

9. A method for encoding, comprising:
determining a predicted motion vector for a macroblock in a right view frame based on a motion vector of a co-located macroblock from the same frame in a corresponding left view frame and motion vectors for neighboring macroblocks in the left view frame.

10. The method of claim 9, further comprising:
performing a less than full range motion refinement on the predicted motion vector to obtain a final motion vector.

11. The method of claim 10, wherein the less than full range motion refinement is centered on the predicted motion vector.

12. The method of claim 9, wherein a median value of the motion vector and the motion vectors is used to determine the predicted motion vector.

13. The method of claim 9, wherein a weighting function is applied to the motion vectors based on a predetermined criteria to determine the predicted motion vector.

14. The method of claim 9, wherein a number of neighboring macroblocks used is based on a desired level of accuracy.

15. The method of claim 9, wherein a number of neighboring macroblocks used is based on a desired level of resolution.

16. A device, comprising:
a base layer encoder;
an enhancement layer encoder connected to the base layer encoder and configured to encode a frame in an enhancement layer; and
the enhancement layer encoder configured to determine a predicted motion vector for a macroblock in the frame in the enhancement layer based on a motion vector of a co-located macroblock from the same frame in the base layer and motion vectors for neighboring macroblocks in the base layer.

17. The device of claim 16, further comprising:
the enhancement layer encoder configured to perform a less than maximum range motion refinement on the predicted motion vector to obtain a final motion vector.

18. The device of claim 16, wherein a median value of the motion vector and the motion vectors is used to determine the predicted motion vector.

19. The device of claim 16, wherein a weighting function is applied to the motion vectors based on a predetermined criteria to determine the predicted motion vector.

20. The device of claim 17, wherein the less than full range motion refinement is centered on the predicted motion vector.

21. The device of claim 16, wherein a number of neighboring macroblocks used is based on at least one of a desired level of accuracy and a desired level of resolution.

22. The device of claim 16, wherein the device supports up to a maximum range search.

23. The device of claim 16, wherein the frame and same frame are stereo video data frames.
